(19) United States
(12) Patent Application Publication
(10) Pub. No.: US 2015/0242409 A1
(43) Pub. Date: Aug. 27, 2015

(54) Automated Data Shaping

(71) Applicant: SourceThought, Inc., San Juan Capistrano, CA (US)

(72) Inventors: Ron Frohock, Trabuco Canyon, CA (US); Chhay Taing, Irvine, CA (US); Chris Andrade, Rancho Santa Margarita, CA (US); Karl Gierach, Irvine, CA (US); Michael Ransom Pennell, San Clemente, CA (US)

(21) Appl. No.: 14/629,334

(22) Filed: Feb. 23, 2015

Related U.S. Application Data
(60) Provisional application No. 61/943,324, filed on Feb. 22, 2014.

(51) Int. Cl. G06F 17/30

(52) U.S. Cl. CPC G06F 17/3053; G06F 17/30864; G06F 17/30498; G06F 17/30581

(57) ABSTRACT

A system for synthesizing a data shape from a plurality of datasets with a plurality of attributes is provided. As a user entity selects one or more attributes, the system could determine the most relevant attributes and transformations that are related to the selected attributes. As the user selects more attributes and transformations, the data shape could take form with updated rankings, and the system could provide more relevant, targeted suggestions. The data shape could then be used to create a synthesized dataset among the plurality of datasets, and could be saved as a type of query for deriving future datasets.

This application claims the benefit of priority to U.S. provisional application 61/943,324 filed on Feb. 22, 2014. This and all other extrinsic references referenced herein are incorporated by reference in their entirety.

### FIELD OF THE INVENTION

The field of the invention is data integration

### BACKGROUND

The background description includes information that may be useful in understanding the present invention. It is not an admission that any of the information provided herein is prior art or relevant to the presently claimed invention, or that any publication specifically or implicitly referenced is prior art.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Many computer systems collect, aggregate, and process data in order to perform tasks and run analytics. There has been, and will likely continue to be, a significant increase in the volume and variety of data available to organizations from various disparate sources. The term “Big Data” is often used to describe this trend. Organizations oftentimes seek ways to use such data in order to gain insight, improve performance, and develop predictive models. Efficiently using data from disparate sources oftentimes requires combining the data into a single dataset before processing the data, which is difficult when each data source has a different structure.

U.S. Pat. No. 5,894,311 to Jackson teaches a system that automatically joins tables when a user selects database variables from different database tables. When a user selects the two variables, the system generates an on-the-fly join command of the tables by using a unique key, such as a customer account variable, that is common to both tables. Jackson's system, however, requires the system to already know what variables are unique to a user, and what variables are common to both tables, to use such variables as a key to join multiple tables. There are many situations when a user might want to join data from a plurality of data sources, but doesn't know what key to use in order to join the different sets of data into a single data source.

US 2011/0320433 to Mohiuddin teaches a system that allows a database administrator to create a database baseview for each table, and associates primary key metadata for the baseview. Mohiuddin's system could then join the tables based upon the primary key metadata in each table's baseview. However, it is oftentimes unrealistic to require a database administrator to create a database baseview for each and every table in a database, since such tasks are quite time-consuming.

US 2012/0330988 to Christie teaches a system that automatically generates queries to join one table with another table. The database creates a table index for one of the tables to identify unique values contained in a column of the table. Then, the system could automatically generate a query to join the indexed table with a non-indexed table based upon the unique values that the database found. Christie's system, however, requires the keys used to join tables to be exact matches with one another, which is not always known by the system. Also, exact column matches may not always indicate that columns should be used to join tables, for example if the column values are dates or consecutive numbers.

Thus, there remains a need for a system and method to join data from disparate sources.

### SUMMARY OF THE INVENTION

The following description includes information that may be useful in understanding the present invention. It is not an admission that any of the information provided herein is prior art or relevant to the presently claimed invention, or that any publication specifically or implicitly referenced is prior art.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of“in” includes “in” and “on” unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

The inventive subject matter provides apparatus, systems, and methods in which a computer system synthesizes a new dataset from a corpus of data sources.

It should be noted that any language directed to a computer system should be read to include any suitable combination of computing devices, including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network. Data received by the computer system is typically stored and processed in a non-transitory computer readable storage medium.

The computer system generally has a data collection module configured to receive one or more datasets from various data sources through a wired or wireless interface (e.g. a serial port, an Internet connection). As used herein, a “data source” is a computer device that transmits a dataset to one or more computer systems. Preferably, such data sources save the dataset on a non-transitory computer-readable medium, such as a file repository, a relational database management system, and a cloud service. Such data sources could be structured (e.g. DBMS) or poly-structured (e.g. XML, JSON, log files, sensor outputs). A single data source could house one or more datasets and a single computer system could access one or more data sources. While some data sources may have metadata on datasets, such as an indicator that an attribute of a database table is a key attribute, other data sources could simply be comma-separated values (csv) that may or may not contain column headings. As used herein, an “attribute” of a dataset is a characterization of a discrete subset of values within the dataset. In a standard database table, a column could be considered an attribute and each column/row intersection could be considered a value. The data collection module typically aggregates all of the attributes from each dataset so that they can be analyzed, processed, and made available to requesting entities. The data collection module also typically stores retrieved datasets and aggregated attributes to a computer-readable memory.

In many cases, the computer system might lack prior knowledge or historical information about the datasets or the data sources, other than a data source and/or dataset exists. When the data collection module sends a request to a data source for dataset information, the computer system gleans (1) dataset information, (2) data attribute information, and (3) data attribute values, and could add this new information to the computer-readable memory—particularly the aggregated set of attributes.

A user interface module could be configured to provide the aggregated set of attributes from all of the datasets to a user interface. Since the entire aggregated set of attributes is typically too large to be displayed on a user interface, the set of attributes is typically filtered, or presented in a tree structure, for ease of navigation. A user entity could then select a subset of the attributes for the new dataset from the user interface. Since it is likely that the selected attributes come from different datasets, the system will need to join the datasets based upon relationships between the datasets, which are typically not known to the system. As used herein, a “user entity” is an entity that requests the new dataset from the system. Contemplated user entities include users that access the system through a user interface, and a calling system that sends electronic requests for data as part of its programming.

The computer system also has a synthesizing engine configured to establish relationships between data attributes of the aggregated set of attributes—typically to determine whether it would be appropriate to join both datasets using related attributes as a join key. The synthesizing engine can be configured to synchronize the data attributes that have a relationship to one another. As used herein, data attributes that are “synchronized” with one another are conformed to one another using one or more transformations on or more attributes to create pairs of identical values that can be used to join the datasets. In some embodiments, the attributes of a selected relationship might be related to one another, but may need to be conformed before the datasets are joined together using the attributes. For example, leading, trailing and imbedded characters such as a “-” can be removed or an integer can be converted to a string field. When such a situation occurs, the data consolidation engine preferably generates a key transform that maps values of one attribute to values of another to ease in the synthesis of the new dataset. In some embodiments, multiple attributes in a dataset could be transformed into a new attribute for that dataset that could be used as a key to join that dataset with other datasets. This property could nest in certain embodiments. For example, when a new dataset is created from a plurality of datasets, multiple attributes of that new dataset could be transformed into a new attribute for that new dataset, which could then be used as a key to join that new dataset with other datasets.

The computer system generally has a synthesizing engine typically establishes relationships using one or more advisors that indicate the likelihood of a relationship between two attributes. Contemplated advisors include profile advisors, structural analysis advisors, data similarity advisors, and entity resolution advisors. Usage history analyzers could also identify a relationship between join keys used in historical requests that have been run on the system to identify attributes that are likely to have a relationship.

Profile advisors typically construct profile results for each attribute and compare the profile results to one another to determine whether the profiles are related to one another. A profile of a data attribute could be generated as a function of values of the data attribute. For example, a profile of a data attribute spanning a plurality of numerical values could be the largest numerical value of all of the values characterized by the data attribute. Profile advisor results are generally then calculated by comparing the profile of one attribute against the profile of another attribute.

Structural analysis advisors typically construct structural analysis results based on structural information about the attributes. Such structural information is typically contained within metadata for an attribute or dataset. Such metadata could include, for example, the name of a data attribute, a data type of a data attribute, or an indicator of whether the attribute is a key attribute (e.g. primary key, foreign key).

Similarity advisors typically construct a similarity result based on a data similarity between actual values of a data attribute for a first dataset and actual values of a data attribute. For a second dataset. For example, attributes that have a high number of unique values that are the same would be more similar than attributes that have a low number of unique values that are the same.

Entity resolution advisors typically apply algorithms to determine whether a data attribute is an entity ID or not. As used herein, an “entity ID” is a primary key to a dataset or entity. For example, a social security number in a dataset including employee information could be categorized as an entity ID for a person.

One or more of the results generated by an advisor could be weighted and aggregated into a Relationship Confidence Metric (RCM), typically measured between 0% and 100%, between the attributes. The RCM aggregates results that analyze an attribute of one dataset and an attribute of another dataset to form a value that represents the likelihood that the attributes are appropriate for use as join keys. The synthesizing engine also typically applies a weighted distribution to each relationship, such that the aggregate sum of all of the weighted results generates an RCM between 0% and 100%. Since a system is rarely 100% confident that two attributes have a relationship with one another (especially attributes from disparate data sources), most of the RCMs will be less than 100%. One or more of these contemplated advisors may not be used if it is determined that they do not significantly improve the calculation of RCM. Similarly, new advisors may be added if it is determined they can improve the calculation of RCM. Exemplary RCM calculations are disclosed in co-pending application Ser. No. 14/628,810 titled “DISCOVERY OF DATA RELATIONSHIPS BETWEEN DISPARATE DATASETS”

The weighted distribution that is applied to each relationship reflects which advisor results are more important than other advisor results. In many cases, the importance of one advisor result over another advisor result is dependent upon the user entity that is requesting the new dataset. The set of attributes that the user entity selects could also be used to influence the weights applied to one advisor result over another.

The system also typically has one or more logs that keep track of a usage history of historical requests that have been processed by the system. The historical queries typically show how often certain attributes have been used to join datasets into a new dataset. While a user entity might be able to define the weighted distribution by submitting a config file or by submitting a weighted distribution through an administrator user interface, a weighted distribution could still be affected by a user history that reflects which RCM relationships that user entity might prefer. Aggregate histories of a group of users that the user entity is a part of (e.g. a system might use a history of all employees in the marketing department within a company where the user entity is an employee), or a global history of all users who have used the system in the past might also be used to influence the weighted distribution for all the advisor results.

In some embodiments, the system could automatically join datasets based upon relationships with the highest RCM values between datasets. In other embodiments, the user interface module could present the relationships and RCM values to the user interface, allowing a user entity to review the various derived relationships and RCM values to select one or more relationships to base the data structure synthesis upon. In other embodiments, the data consolidation engine only selects a relationship, or only presents a relationship to a user entity, when the generated RCM is at least a defined threshold, for example at least 40%, 50%, 60%, 70%, or 80%. Such thresholds are generally defined through a user interface by an administrator. The generated confidence metrics of other relationships could be altered by a user's selection of relationships. Preferably, the synthesizing engine could be configured to update at least some of the RCM values as a function of a user entity's selection of suggested relationships.

A relationship could be between two or more attributes that are equated with one another. While most attributes are likely derived directly from the datasets, some attributes might be constructed through one or more transform functions. A transform function might be applied to an attribute of a dataset to create a new attribute, to several attributes of a dataset to create a new attribute, or to several attributes of several joined datasets to create a new attribute. Attributes might only be equated with one another after a transform is applied to one or more of the attributes to ensure that they can be equated with one another. Preferably, the interface module presents the derived relationships as a ranked list of suggested relationships, with the relationships having the highest value presented first.

The computer system could also suggest attributes or transformations to a user entity based upon the attributes that were selected by the user entity. The synthesizing engine could generate the list of suggested attributes as a function of the selected attributes. Since the suggested attributes are usually included in the list of available attributes that have not been selected by the user interface, the ranked list of suggested attributes could simply be a re-ranked list of the unselected attributes. The ranking of suggested attributes could be based, at least in part, on one or more connections between the suggested attributes and the selected attributes, the confidence in those connections, and the frequency of prior combinations of attributes that included both suggested and selected attributes.

In a preferred embodiment, the connections between a selected attribute and a suggested attribute has a quantifiable relevance metric associated with the relationship. Having a quantifiable relevance metric allows the relevance ranking engine to adjust the ranking of suggested attributes according to a numerical algorithm. In embodiments where the connection matrix is represented as a nodal map between attributes, the relevance metric could be derived as a function of a numerical distance between a suggested attribute and a selected attribute. The connections themselves could also be weighted. For example, attributes sharing a dataset might be given a higher weight than attributes connected through a transformation. Relationship connections are typically defined by their RCM.

A traveling salesman-type algorithm could be applied to determine the minimum numerical distance between each suggested attribute and each selected attribute in a nodal map, for example, giving a higher weight to suggested attributes that have a smaller numerical distance to selected attributes, giving a higher weight to suggested attributes that are closely connected to a plurality of selected attributes, giving a higher weight to suggested attributes that are part of the same dataset as a selected attribute, and/or giving a higher weight to suggested attributes that is associated with a suggested transformation. As used herein, a “transformation” for an attribute is a function that is applied to an attribute to alter its data, such as a transformation function that transforms attribute values from one form to another (e.g. a transformation from a string to an integer or from a date to a timestamp), or a normalization that alters metadata of related attributes to the same or similar metadata (e.g. normalizing the attribute “Name” and “First Name, Last Name” to be “Full Name”).

Suggested transformations could also be ranked based upon a determined relevance metric between the suggested transformations and the selected attributes, or between the suggested transformations and the suggested attributes. Preferably, the only suggested transformations are those that are connected to a selected attribute by a relationship path. Likewise, preferably the only suggested attributes are those that are connected to a selected attribute by a relationship path. The synthesizing engine could filters out all other transformations and attributes from the list of suggested transformations and attributes. As used herein, a “relationship path” is a path from one attribute to another attribute connected to one another by one or more relationship links which include a link to another attribute in the same dataset and a link to another attribute in a different dataset via an established possible relationship. The attributes used in a relationship path include both attributes from the original dataset and new attributes created as a result of one or more transformations. In some embodiments, a computer system only considers a relationship path valid if all of the relationships along the path have a minimum threshold RCM value, such as 80%.

The list of ranked suggested attributes and/or list of ranked suggested transformations are preferably provided to a user interface via the user interface module, which presents one or more ranked lists. As a user selects a suggested attribute, the attribute is preferably then categorized as a selected attribute, which could trigger a re-ranking of the suggested attributes (minus the newly selected attribute) and/or a re-ranking of the suggested transformations. Likewise, as a user selects a suggested transformation, the transformation is preferably then categorized as a selected transformation, which could trigger a re-ranking of the suggested attributes and/or a re-ranking of the suggested transformations (minus the newly selected transformation).

After a user selects attributes from the list of available attributes and list of suggested attributes (and sometimes a list of suggested transformations), the user could then send a request to generate the new dataset containing all of the selected attributes (and possibly transformations of those attributes). A dataset generation module would then generate the new dataset that includes all the selected attributes.

After the user entity selects attributes, transformations, and relationships from the various ranked lists, the user entity could send a request to generate a new data shape from the selections as a function of the ranked possible relationships, or could generate the new dataset itself as a function of the ranked possible relationships. As used herein, a “data shape” is a construct used by a computer system to construct a new dataset from derived attributes, transformations, and/or relationships and preferences defined by a user entity. Contemplated elements of a data shape include selected attributes, selected transformations, identifiers of datasets that own the selected attributes, and identifiers of data sources that the computer system retrieved the datasets from. In some embodiments, a user entity might define the data shape to include criteria for certain attributes, transformations and relationships instead of specific selections. For example, the user entity could define a shape that includes a specific set of attributes and automatically includes other suggested attributes and transformations with TRR above a defined threshold (typically selected by default or defined by the user entity), and uses the highest RCM to join all suggested attributes. In some embodiments, a user entity might instruct a data generation module to generate a new data shape in one session, and synthesize a new dataset from the data shape in another session. Typically, when the data generation module synthesizes the new dataset from a data shape, the system ensures the datasets are current or retrieves updated datasets (and hence updated attribute values for those datasets) from the data sources before constructing the new dataset. In such embodiments, the data shape could act like a saved dynamic query implemented by the system.

New synthesized datasets typically contain all of the selected attributes (and possibly transformations of those attributes). The data generation module typically synthesizes new datasets by including all of the selected attributes as a function of the selected relationships, and by performing any functions (e.g. transformations) that were selected. The new dataset is typically then stored into a computer-readable memory, and could be presented to a user interface at any time.

Various objects, features, aspects and advantages of the inventive subject matter will become more apparent from the following detailed description of preferred embodiments, along with the accompanying drawing figures in which like numerals represent like components.

One should appreciate that the disclosed techniques provide many advantageous technical effects including the ability to join previously unknown disparate datasets into a new dataset.

The following discussion provides many example embodiments of the inventive subject matter. Although each embodiment represents a single combination of inventive elements, the inventive subject matter is considered to include all possible combinations of the disclosed elements. Thus if one embodiment comprises elements A. B, and C, and a second embodiment comprises elements B and D, then the inventive subject matter is also considered to include other remaining combinations of A, B, C, or D, even if not explicitly disclosed.

### BRIEF DESCRIPTION OF THE DRAWINGS

FIG. 1 is a hardware layout of an exemplary inventive system.

FIG. 2 is a software layout of the computer system in FIG. 1.

FIG. 3 shows an exemplary universe graph of a plurality of datasets.

FIG. 4 shows an exemplary new dataset constructed from a selection of attributes and transformations.

### DETAILED DESCRIPTION

The inventive subject matter provides apparatus, systems, and methods in which a computer system synthesizes a new dataset from a corpus of data sources.

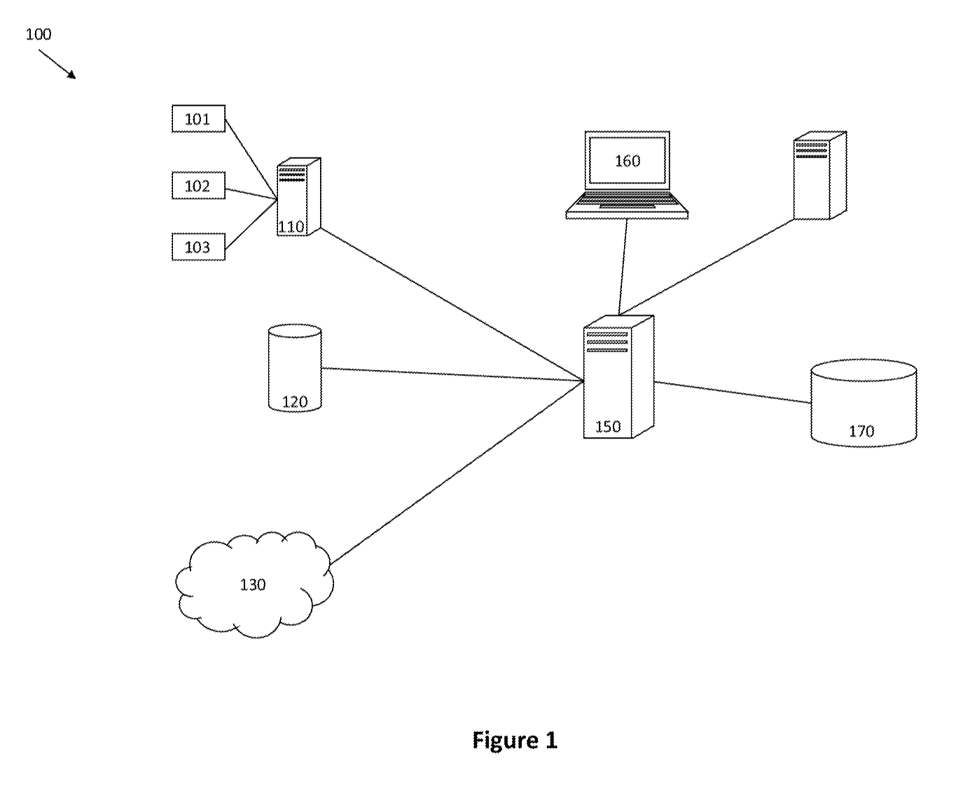

In FIG. 1, a system has data sources 110, 120, and 130 functionally connected to computer system 150, which is functionally connected to user interface 160, calling computer system 170, and data repository 180. Data source 110 is as a computer system 110 that collects data from sensors 101, 102, and 103 and stores data collected from each sensor into datasets saved in a memory. Such data sources typically store collected information in a text file, such as a log, csv, JSON or an XML file. Data source 120 is a DBMS, such as SQL® or Oracle®, that keeps data in a structured environment, and typically keeps metadata log files on its datasets. Data source 130 is a cloud storage repository holding many different types of structured and poly-structured datasets. While data sources 110, 120, and 130 are represented as a poly-structured data source, a structured data source, and/or a multi-structured data source, any number of data sources and any type of data source could be used without departing from the scope of the invention. The data sources coupled to computer 150 could number in the hundreds or even thousands, to provide a large corpus of datasets that may or may not be known to computer system 150, where many of the data sources might use different types of data structures.

Computer system 150 is functionally coupled to data sources 110, 120, and 130 in a manner such that computer system 150 could receive or retrieve datasets from data sources 110, 120, and 130. While computer system 150 could be physically coupled to each data source 110, 120, and 130, computer system 150 is preferably functionally coupled to each data source through a network link, such as an intranet or the Internet. Computer system 150 is configured to retrieve datasets from the various data source 110, 120, and 130, and consolidate the retrieved datasets into one or more new datasets, which are saved in data repository 180—a non-transitory computer readable medium functionally coupled to computer system 150. Data repository 180 could also be considered a data source having one or more datasets that computer system 150 could draw upon. Data repository 180 could also contain a historical log that tracks all retrieving, profiling, querying and conforming of datasets, attributes of datasets, and associated user entity interactions to enable the system to learn from itself by analyzing trends found in the historical log.

Computer system 150 could be controlled by user interface 160, which is shown as a display screen and a keyboard, but could comprise any known user interface without departing from the scope of the invention, such as touch screens or terminal devices. In a typical embodiment, a user might access computer system 150 through user interface 160 to request that two or more datasets be analyzed to derive associated relationships and RCMs. A user interface might also define criteria for a regular dataset poll such as data source location and data type such that computer system 150 will analyze the data source automatically based on a periodic schedule or an event such as a file transfer to import an updated dataset from that data source.

User interface 160 could be configured to present a list of attributes from the retrieved datasets, whether the datasets were specified to be retrieved by the user entity or were automatically retrieved as a part of a regular polling task. Through user interface 160, a user entity could select two or more attributes to be included in a new dataset. After selecting a first dataset or a first attribute from the first dataset, the user interface could present other attributes from datasets that are related to the first dataset or attribute. Computer system 150 could compile a list of related datasets as those that have an attribute with a relationship link (a direct relationship link with one another or an indirect relationship link through one or more other datasets) with the first selected dataset or attribute where each relationship has an RCM exceeding a defined threshold specified by the user (e.g. 75%). Computer system 150 could then present the information to user interface 160, preferably by showing the recommended highest RCM relationship path between the first selected dataset or attribute to other attributes through any intermediate datasets. The user entity could then select additional attributes from related datasets in a similar manner and can select a different relationship path from a list or relationships with RCM above the specific threshold. The dataset may have already been retrieved by computer system 150. If the dataset has not been retrieved by computer system 150, any selected datasets and associated attributes could then be retrieved from data sources 110, 120, and 130.

In some embodiments, user interface 160 could show the recommended highest RCM relationship path (or paths were a plurality of RCM relationship paths are available) between the first selected attribute to other attributes through any intermediate datasets. The user entity could then review the various relationship paths and verify that a path should be used to join datasets by selecting one or more of the presented paths. In other embodiments, computer system 150 might automatically pick the relationships as a function of the RCMs, for example by selecting the relationships with the highest RCMs to join the datasets.

Computer system 150 could also be configured to derive the TRR scores for unselected available attributes and transformations related to the selected attributes. The TRR scores, based upon the user's selections, could be used to rank suggested attributes and/or suggested transformations, which are then presented to user interface 160. Computer system 150 could be configured to present any of the available attributes, suggested attributes and/or suggested transformations to the user interface 160, preferably displaying the highest ranked suggested attributes and transformations first. The user entity could select additional attributes and transformations in a similar manner which could then alter the TRR scores, suggested attributes and suggested transformations. Once a user entity has chosen a set of attributes and transformations to be applied to attributes of the new dataset, computer system 150 could join appropriate datasets in order to provide a new dataset containing all of the selected attributes (possibly with selected transformations applied to some of the attributes). The source datasets may have already been retrieved by computer system 150, or if not, any selected datasets and associated attributes would then be retrieved from data sources 110, 120, and 130 for incorporation into the new dataset.

In other embodiments, calling computer system 170 could request data from computer system 150 through an application program interface (API) which is preferably implemented as REST HTTP requests but can be implement using different API frameworks. Using the API, calling computer system 170 could request two or more attributes from 2 or more datasets to be retrieved from data sources 110, 120, and 130, preferably from a list of available attributes. Computer system 150 would then either 1) provide the selected attributes based on joining the datasets using automatically selected relationships (e.g. selected by choosing the join paths with the highest RCM values) or 2) provide a response through the API with the various relationships and allowing calling computer system 170 to respond with a selection of specific relationships to be used to join the datasets. Computer system 150 would then construct the new dataset, store the new dataset in memory, such as a local memory or in data repository 180 so that computer system 170 could retrieve it or pass the dataset directly to computer system 170 through the API.

Computer system 150 also could send suggested attributes and/or suggested transformations to calling computer system 170 as a function of one or more TRR scores derived from the selected attributes. Calling system 170 could perform an automated analysis of the suggestions (e.g. picking the top 5 suggestions from each list, or picking the suggestions with a TRR score above a certain threshold), or calling system 170 could pass those suggestions on to another system (not shown), for example another user interface. In either embodiment, calling system 170 could then pick from the available attributes, suggested attributes and/or suggested transformations, and computer system 150 could then generate a new dataset containing all of the selected attributes (possibly with selected transformations applied to the attributes).

By constructing RCMs for a large corpus of data attributes, the system eliminates, or at least substantially reduces, the requirement for human users to investigate each and every dataset and construct a data attribute map. This enables faster integration of new data attributes to the corpus, which streamlines the ability for a system to derive new and constructive meaning. By providing suggested attributes and suggested transformations to a user entity, the system allows a user entity to quickly learn about other, relevant attributes that could be added to the new dataset, as well as transformations that might be applied to some attributes that would greatly improve the consistency and usability of the new datasets. As the system constantly updates TRR scores based upon the user entity's selections, the final composition of the new dataset could be dynamically crafted through this feedback loop.

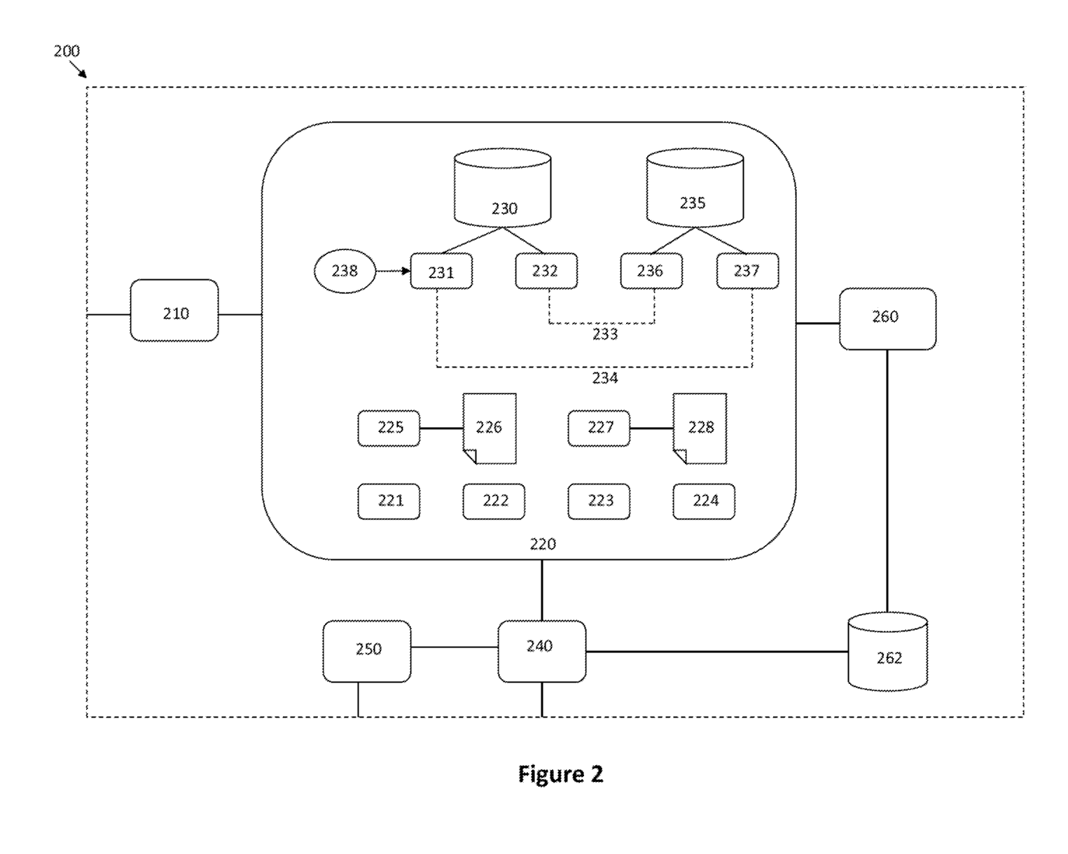

In FIG. 2, an exemplary software schematic 200 of computer system 150 is shown, having a data collection module 210, synthesizing engine 220, interface module 240, API module 250, and data consolidation engine 260. The system is used to derive a new dataset from a plurality of datasets collected by data collection module 210.

Data collection module 210 is a software module that is configured to collect any number of datasets from any number of data sources coupled to computer system 150. Data collection module 210 could be configured to process requests that are submitted by a user entity through interface module 240, for example from a user interface (not shown) or from a calling computer system (not shown) through API module 270. In some embodiments, the user might not submit a direct request for specific datasets, but might instead submit a request for specific attributes. Where a user requests attributes, data collection module 210 could be configured to verify relevant datasets have already been retrieved or retrieve the relevant datasets that contain the requested attributes. In other embodiments, data collection module 210 is configured to retrieve all datasets from all known data sources, or metadata from all datasets, in order to create an aggregated list of all available attributes. Included in these attributes could be new attributes formed as a transformation upon existing attributes. This aggregated list of attributes could be provided to a data entity through interface 240, and the data entity could then select one or more attributes from the list to be included in the new dataset. Here, data collection module 210 has retrieved dataset 230 having attributes 231 and 232, dataset 235 having attributes 236 and 237, and transform 238 which could be applied to attribute 231, and has passed them to synthesizing 220 for analysis. In some embodiments, transform 238 could be associated with the dataset and is retrieved from the data source along with the dataset. In other embodiments, synthesizing engine 220 analyzes all retrieved attributes and derives transformations that could be applied to various attributes. For example, synthesizing engine 220 could look for any attributes having values following the pattern “XXX-XX-XXXX” to determine that the attribute is likely to be a social security number that could have a transform applied to it in order to eliminate the dashes from the social security number.

Synthesizing engine 220 analyzes the corpus of datasets and attributes to derive and determine potential relationships between attributes. These relationships are typically quantified by an RCM-a quantitative indicator of the confidence that a group of attributes (typically two) are related and can be used to join different datasets. Defining each relationship's RCM on a large corpus of datasets, and data attributes for those datasets, greatly improves the ability for the computer system to derive new datasets. Synthesizing engine 220 typically has a plurality of advisor committees—profile committee 221, structural analysis committee 222, data similarity committee 223, and entity resolution committee 224—which are used by synthesizing engine 220 to recognize potential relationships and provide relationship results that are used to construct an RCM for a relationship. Each committee could have any number of advisors. While synthesizing engine 220 is shown with four advisor committees, more or less advisor committees could be used without departing from the scope of the invention. In order to construct an RCM, synthesizing engine 220 subjects data attributes 231, 232, 236, and 237 to the automated advisors for analysis. Each advisor provides a different expertise in specific areas of interrogating data attributes in order to determine whether a relationship exists, and how likely the relationship is to exist. Each advisor committee 221, 222, 223, and 224 preferably weights each of its advisor results according to an algorithm, and the weighted results are all then assembled into a single aggregated result—the RCM. Here, the advisor committees have determined that there is a possible relationship between attribute 231 and 237 having an RCM of 234, and a possible relationship between attribute 232 and 236 having an RCM of 233.

Machine learning and statistical analysis could be utilized to tune contributions of individual advisors and/or committees to the RCM. For example, users and calling systems could select certain relationships, or join paths, over other relationships, influencing synthesizing engine 220 to alter its weight measurements to match the selected relationships. By analyzing historical relationship paths, users could train synthesizing engine 220 to weigh certain advisor results over other advisor results by validating particular relationships. Based on usage and user validation of relationships, the RCM algorithms could adjust to increase the RCM of newly discovered relationships with characteristics similar to relationships that have been used and validated to join datasets. Conversely, the RCM algorithms could adjust to decrease the RCM of newly discovered relationships with characteristics similar to relationships that have not been used to join datasets.

Profile committee 221 generally comprises one or more profiling advisors that comprise a series of heuristic examinations targeting the composition of data attributes. Exemplary heuristic examinations include various statistical calculations, such as similar minimum, maximum, mean, standard deviations, cardinality of data attribute values, uniqueness of data attribute values, and length of attributes. Frequency distribution of common formats including text, numeric and character patterns along with the frequency of particular data attribute values such as blanks, nulls and O's are also key measures could also be utilized across profiling advisors. Each heuristic examination generates a profile for a first attribute of a first dataset and a separate profile for a second attribute for a second dataset, and then compares the profile results against one another to calculate the profile advisor result, typically between 0% and 100%.

For example, where a profiling advisor examines how similar each attribute's mean is relative to one another, the heuristic examination would generate a profile of the mean of the first attribute in the first dataset, a profile of the mean of the second attribute in the second dataset. The profile advisor would compare each of the means against one another (typically by placing the smaller mean in the numerator and the larger mean in the denominator) to produce a profile advisor result. If the means are exactly the same, the profile advisor result would be 100%. But if the mean of one attribute in one dataset was 80 and the mean of the other attribute in the other dataset was 100, then the profile advisor result would be 80%.

Structural analysis committee 222 generally comprises one or more structural analysis advisors that utilize cues provided in description of data attributes or metadata consumed regarding data attributes from a source system (such as a DBMS) or imbedded in the source file (e.g. column headers, xml tags). Exemplary structural analysis advisors algorithms include an evaluation of the similarity of data attribute names, reference data attributes, whether both data attribute names are synonyms, an indicator of whether an attribute is a primary key, an indicator of whether an attribute is a foreign key, and an indicator of whether the attributes are related as primary and foreign keys. Structural analysis advisors contemplate utilization of linguistic approaches such as abbreviation normalization or synonym expansion to determine possible attribute name similarity. Each structural analysis advisor generates a structural analysis result, typically between 0% and 100%, as a function of structural information about the pair of attributes.

For example, where a structural analysis advisor attempts to determine whether two attributes are synonyms of one another, the structural analysis advisor might look up the name of the first attribute to find a list of synonyms for the first attribute, look up the name of the second attribute to find a list of synonyms for the second attribute, and would return 100% if either attribute were found in the other list of synonyms, 50% if the synonyms of one attribute were found in the list of synonyms of the other attribute, and a 0% of if there was no overlap in the list of synonyms.

Data similarity committee 223 generally comprises one or more data similarity advisors that comprise one or more algorithmic evaluations across the values of data attributes to locate data attributes that have content from the same set of values. Since calculating exact matches for a large population of data attributes is computationally expensive, data similarity advisors preferably work to determine relevant sample datasets for evaluations, for example by only searching attributes that have already returned a non-zero relationship from another advisor. Advisors can preferably request additional data attribute value samples to aid in confirming prior findings. Similarity measures utilized include, but are not limited to, Jacquard Similarity Coefficients, Overlap Coefficients, Dice Coefficients and Morista-Indexes.

Data similarity advisors preferably include the capability of constructing a transformation, which conforms one or both data attribute allowing them to match the other attribute in the other dataset. These transformations could be formed by an ordered set of simple character manipulation or mathematical conversions of one or more data attributes. For example, a data similarity advisor might apply a transformation to an attribute to convert a social security number with embedded dashes to remove the dashes.

Entity resolution committee 224 generally comprises one or more entity resolution advisors that assess whether one, or both, of the attributes are entity IDs. For example, an entity resolution advisor might determine that an attribute has values that are all unique, indicating that the attribute has a high likelihood of being an entity ID. In another embodiment, an entity resolution advisor might search for all historical entity IDs that have been used by other users, and could indicate that an attribute was used as an entity ID in a previous join. Relationships where both attributes are recognized as entity IDs are ranked higher than relationships where only one attribute is ranked as an entity ID.

Each of the results for a relationship for a relationship group (typically two attributes) from the advisors are generally weighted by synthesizing engine 220 according to an algorithm that aggregates all of the advisors results into a single RCM. The algorithm preferably applies a weighted distribution to each advisor result. While the weighted distribution could be the same for all user entities that request information from synthesizing engine 220, contemplated embodiments have weighted distributions that are customized for specific user entities. This is particularly useful where the system stores a historical log of a user entity's past selections and/or preferences. The weighted distribution could be determined as a function of the user entity's history. In some embodiments, it might be beneficial to look at a discrete group of users, for example the marketing department within a company. In those situations, the weighted distribution could be determined as a function of the user entity's group history. Where all user entities are treated equally, the weighted distribution could be determined as a function of a universal history of all user entities.

Advisors from the same or different committees could be combined typically using decision trees to create new advisors which can then be weighted and included in the RCM calculation or can set the RCM to 0 thereby eliminating the relationship. For example, a Boolean field (structural advisor) that has only 1 value (profile advisor) cannot be a joinable key. Each of the weights for each of the results preferably adds up to be 100%, although in some embodiments the weights might add up to be more or less than 100%.

Once the RCMs are constructed, relevant attributes could be provided to a user entity based upon the user entity's selection of available attributes. When an attribute is selected by a user entity through interface 240, synthesizing engine 220 could provide a list of suggested attributes that are potentially related to the selected attribute. Attributes that are potentially related could be, for example, attributes that belong to the same dataset as the selected attribute, or attributes that are connected via a relationship path where every relationship has an RCM above a specified threshold value, such as, for example, 50% or 75%. Synthesizing engine 220 could also provide a list of suggested transformations for one or more attributes that could be used to synchronize two or more attributes with one another.

Preferably, the suggested attributes and/or suggested transformations are ranked in order of how strongly they are related to the selected attributes and/or transformations using TRR scores. Synthesizing engine has an attribute TRR generator 225 and a transformation TRR generator 227. Attribute TRR generator 221 analyzes the attributes that were selected, and generates a list of TRR attribute scores 226. Likewise, transformation TRR generator 227 analyzes the selected attributes, and generates a list of TRR transformation scores 228. The list of TRR attribute scores 226 and the list of TRR transformation scores 228 are then used by interface module 240 to generate a ranked list of suggested attributes and a ranked list of suggested transformations, which are presented to a remote system, such as a user interface or a calling system (via API 250). Suggested attributes (available attributes that have not been selected) are ranked as a function of the TRR attribute scores. Generally the higher the TRR attribute score, the higher the ranking of the suggested attribute. Likewise, suggested transformations are ranked as a function of the TRR transformation scores. Generally, the higher the TRR transformation score, the higher the ranking of the suggested transformation. When a user entity selects a suggested attribute and/or a suggested transformation, attribute TRR generator 225 could analyze the selections to update the list of TRR attribute scores, and transformation TRR generator 227 could analyze the selections to update the list of TRR transformation scores.

Machine learning and statistical analysis could be utilized to improve the TRR based on interactions with a user entity. As user entities select certain suggestions (positive responses) and do not select other suggestions (negative responses), these interactions provide a set of positive and negative responses along with the corresponding characteristics and relationships of the suggested attributes and transformations. A record of every user entity's preferences is preferably stored in a historical log of events. The synthesizing engine could then alter the weighting and decision trees used in any algorithm that calculates the TRR to improve the suggestions. Based on these historical user selections, the TRR algorithms could be adjusted to increase the TRR score of attributes and transformation with the characteristics similar to those that were suggested and accepted when the user entity had previously selected similar data sets and attributes. Conversely, the TRR algorithms could adjust to decrease the TRR of attributes and transformation with characteristics similar those that were suggested but rejected when the user entity had previously selected similar data sets and attributes. Such adjustments could be applied only to a specific user entity, only to a specific group of user entities, or globally to all user entities accessing the system.

As the remote system continues to make selections, the attribute TRR generator 225 and the transformation TRR generator 227 continue to update and re-generate TRR attribute scores and TRR transformation scores. When the remote system selects one or more of the suggested transformations, attribute TRR generator 225 and transformation TRR generator 227 could generate TRR scores as a function of the newly selected transformations as well as the newly selected attributes. In some embodiments, interface module 240 could receive a command to regenerate the list of suggested attributes and list of suggested transformations. In other embodiments, interface module 240 could automatically update the list of suggested attributes and the list of suggested transformations as selections are made. The new dataset could be generated when a predetermined trigger from interface module 240 has been met. Exemplary triggers could be, for example, when the remote system has made a selection of attributes for a second time, or when the remote system has sent a command indicating that the new dataset should be generated.

Once a user entity has selected a set of attributes (and sometimes also a set of transformations), dataset generation module 260 then creates a new dataset as a function of the selected attributes and, in some embodiments, as a function of the selected transformations. The new dataset is then generally saved to data repository 262. Data repository 262 is a computer readable medium that could utilize the new dataset in a variety of ways. In some embodiments, interface module 240 will retrieve the new dataset for display to a user interface, or for export to a calling system. In some embodiments the dataset could be transmitted to a remote data repository, such as a data warehouse or even an unstructured data repository. In still other embodiments data repository 262 could store the new dataset in memory until a command is received to access the new dataset (e.g. export the dataset, view the dataset, or delete the dataset). Data repository 262 preferably also holds historical transaction data used to update and modify weights and/or decision trees used to derive a TRR score.

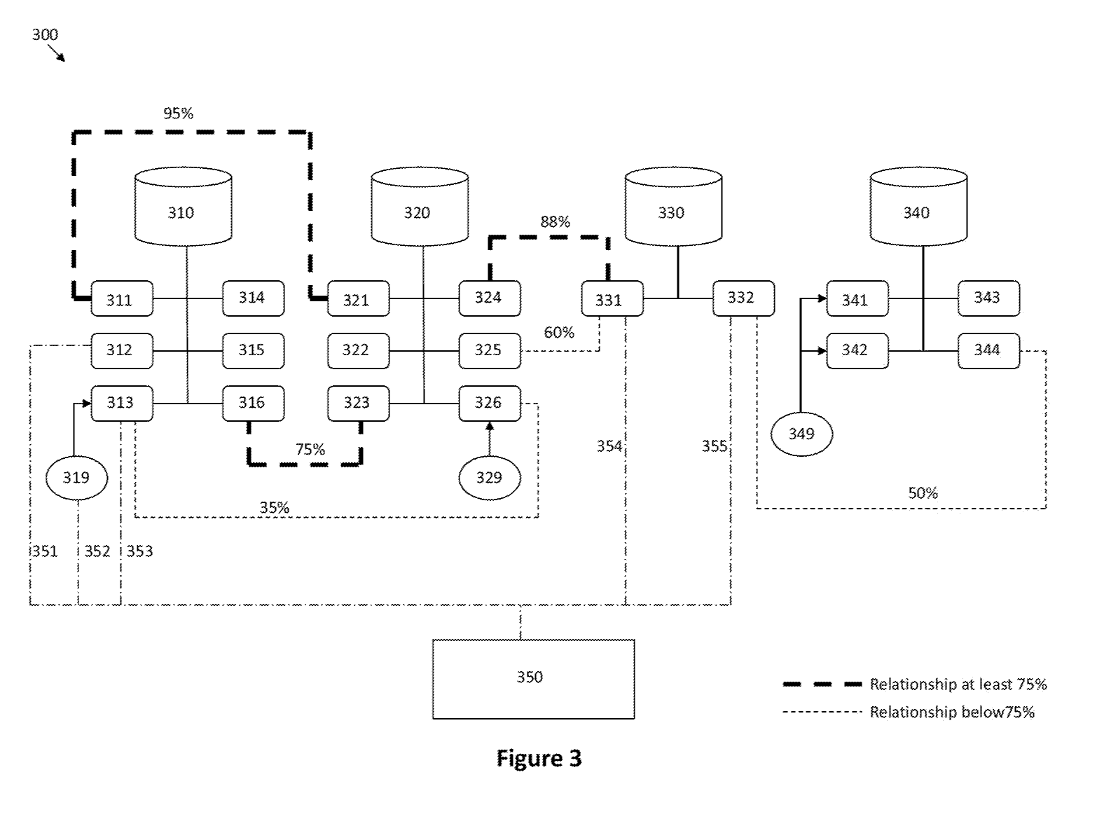

In FIG. 3, an exemplary universe graph 300 shows datasets 310, 320, 330, and 340. Each dataset 310, 320, 330, and 340 has been retrieved by a data collection module from one or more data sources. Dataset 310 comprises attributes 311, 312, 313, 314, 315 and 316. Dataset 320 comprises attributes 321, 322, 323, 324, 325, and 326. Dataset 330 comprises attributes 331 and 332. Dataset 340 comprises attributes 341, 342, 343, and 344. Transform 319 could be applied to attribute 313, transform 329 could be applied to attribute 326, and transform 349 could be applied to attributes 341 and 342. Each attribute and transform is represented as a node in the universe graph, with a line representing a relationship to a dataset, a regular dotted line representing a relationship that has been recognized by the synthesizing engine, and an irregular line representing a selection by a working graph.

As used herein, a “universe graph” is a graph that depicts the entire corpus of all datasets, attributes, and transformations that the data collection module has retrieved from various data sources, represented here by universe graph 300. The subset of the universe graph in the scope of the contemplated new dataset is called a working graph, represented by working graph 350. Working graph 350 is determined or set by a user entity via an interface module or by a calling system via an API, and represents a set of selected attributes, and sometimes transformations, of interest. Here, working graph 350 has made a selection 351 of attribute 312, a selection 352 of transformation 319, a selection 353 of attribute 313, a selection 354 of attribute 331, and a selection 355 of attribute 332.

Some of the attributes have one or more transformations associated with the data attributes. Transformations are depicted on the universe graph as an oval node connected to an associated attribute with an arrow line. Such transformations could be, for example, expressions that define how a data attribute might be transformed from one form to another form. Transformations could also be filters, aggregations, or transpositions that combine or select information from different rows to include in the new data set. For example, a date attribute filter could limit the rows to a particular date range or an aggregation could sum amounts from multiple rows onto a single row in the new dataset. Preferably, when such transformations are applied to an attribute, the attribute in the dataset does not actually change, but rather a new attribute is created, which is then incorporated into the new dataset instead of the original attribute. Transformations could be applied to a single original attribute to generate a single new attribute (e.g. a transformation that changes original string values to new integer values), transformations could be applied to a single original attribute to generate a plurality of new attributes (e.g. a transformation that parses a composite text attribute like full name to separate first and last name attributes), or transformations could be applied to a plurality of original values to generate a single new attribute (e.g. a transformation that changes an original length attribute, an original width attribute, and an original height attribute into a new volume attribute). Both attributes and transformations are referred to as nodes of universe graph 300.

In universe graph 300, a synthesizing engine has analyzed each dataset and attribute, and determined that there exists a relationship between attributes 311 and 321 having an RCM of 95%, a relationship between attributes 313 and 326 having an RCM of 35%, a relationship between attributes 325 and 331 having an RCM of 60%, a relationship between attributes 316 and 323 having an RCM of 75%, a relationship between attributes 324 and 331 having an RCM of 88%, and a relationship between attributes 342 and 344 having an RCM of 50%. The RCM of each relationship has been calculated by aggregating weighted results between automated advisors analyzing each relationship based upon various algorithms. No relationships have been found for attributes 315, 322, 341, or 342.

A threshold amount of 75% has been defined by the system to illustrate which relationships are preferred by the system. In an exemplary embodiment, the system would be configured to only use, or display, relationships having an RCM value at or above the threshold amount. The threshold amount could be set by a user or by a computer algorithm. In an embodiment where a user chooses which relationship to use, the computer system might indicate to the user that only one relationship can be used to join dataset 320 to dataset 330 (the relationship between attributes 324 and 331), no relationships can be used to join dataset 330 to dataset 340, but three different relationships could be used to join relationship dataset 310 to dataset 320 (the relationship between attributes 311 and 321, between attributes 312 and 325, and between 316 and 323). A user interface could be presented to the user that illustrates the three relationships ranked by RCM value (e.g. 311-321: 95%, 312-325: 90%, 316-323: 75%). In another embodiment, the computer system could automatically choose to combine the four datasets using the highest ranked relationships.

Universe graph 300 provides an easy way for a system or a user to assess the most likely and valuable join between datasets. For each of the dataset pairs in FIG. 3, the highest RCM between datasets is the most likely join key (e.g. join path 311 and 321). However, other relationships are still valuable if they are at or above the threshold amount, and are useful to show a user should the user wish to use an alternative high RCM join path. User interfaces or calling systems could be configured to select different relationship edges to use under different circumstances, and the RCM will indicate the likelihood that the join will produce usable results.

Another use of the system is to provide indirect joins using an RCM. For example, where a user or a system wishes to join dataset 310 with dataset 330, which the system analyzed and didn't find any attributes that had a common relationship, the system determined that utilizing dataset 320 could provide a join option between datasets 310 and 330. If the system joins dataset 310 with dataset 330 using the relationship between attributes 311 and 321, and then joins dataset 320 with dataset 330 using the relationship between attributes 324 and 331, the system could create a new dataset containing attributes from both dataset 310 and dataset 330. However because the system threshold is set at 75%, the system would not be able to join dataset 310 with dataset 340. The system could only join dataset 310 with dataset 340 if the system were to lower its relationship threshold to 50% or lower, so that the relationship between attribute 332 and attribute 344 could be used.

Once a universe graph with potential relationships has been constructed by a synthesizing engine, the system could actively provide attribute suggestions and/or transform suggestions. Such suggestions could be made as the user entity selects attributes or after the user entity submits a selection of a set of attributes. When the user entity selects an attribute, the system preferably suggests all attributes that are related to the selected attribute by a relationship path that is greater than the threshold RCM value, which is 75% in this situation. For example, if a user selects attribute 312, the system could suggest attributes 311, 313, 314, 315, and 316 since they all share dataset 310, could suggest attributes 321, 322, 323, 324, 325, and 326 since they are connected via a relationship between attributes 311 and 321 (among others), could suggest attributes 331 and 332 since attribute 324 is connected to attribute 331 via a relationship with an RCM above the threshold value, and could suggest transformations 319 and 329 since they transform one of the suggested attributes. The system would not suggest any of the attributes 341, 342, 343, or 344, or transform 349 since those attributes are not connected to selected attribute 311 via a relationship path where every relationship has an RCM value larger than the threshold amount.

Other relationships besides RCMs could be used to determine if attributes are sufficiently connected to a selected attribute. For example, Utilization Metrics (UM) and Navigation Tracking (NT) could also be used. UMs are metrics that track how various attributes have been historically used and combined by a group of entities. For example, if more than 100 previous user entities in a first group of user entities have generated new datasets containing attribute 311 and attribute 321, then the UM relationship between those two attributes might be increased for a user entity of that first group, but decreased for a user entity of a different group. Similarly, if only 10 previous user entities in the first group of user entities have generated new datasets containing attribute 313 and attribute 326, then the UM relationship between those two attributes would be lower than the UM relationship between 311 and 321 for the first group. The UM relationship could vary based on the users that combine these attributes, the number of times the combined dataset was generated or requested, the type of request (e.g. is the dataset being used in discovery, testing or production) and could incorporate other utilization metrics.

NTs are metrics that measure the frequency a relationship has been used to navigate and join different datasets and attributes on those data sets. For example, assume the relationship between 311 and 321 was used 100 times to join datasets 310 and 320 when attributes 312 and 321 were combined on a new dataset, and assume the relationship between 316 and 323 was used only 10 times when attributes 312 and 323 were combined on a dataset. If the user selects attribute 312, then attribute 321 would have a higher NT metric when the relationship between 311 and 321 is used to join the datasets, and attribute 326 would have a higher NT metric when the relationship between 316 and 323 is used to join the datasets.

Once any selections are made by a user entity for working graph 350, the attribute TRR generator and transformation TRR generator (referred to as TRR generators) then construct TRR scores for each unselected attribute and unselected transformation, which would be used to recommend unselected attributes and unselected transformations from universe graph 300. As the selections of working graph 350 change, the TRR scores will also change. Also, if new datasets are incorporated into the working graph, the TRR scores might also change.

The TRR generators could weight certain relationships higher than other relationships depending upon a user entity of the system. For example, a user entity might have historically picked certain attributes to be included with one another in new datasets, thus that user's UM relationships might be weighted heavier than other user's UM relationships. Other members in a group of user entities (e.g. other employees at the same company) might have historically picked certain attributes to be included with one another in new datasets, thus those member's UM relationships might be weighted heavier than UM relationships outside of that group, but lower than UM relationships associated with the user entity itself.

In order to construct a ranked list, the system first analyzes all of the nodes in universe graph 300 that have a relationship with selected nodes of working graph 350 to select a number of suggestion candidates. A relationship can be defined by one or more of the solid lines, dotted lines, and arrows that connect a path between a selected node and an unselected node. A path can be direct requiring a single connecting relationship to link the nodes (e.g. attribute 311 is connected to attribute 321 using a relationship), or a path can be indirect requiring more than one connecting relationship to link the nodes (e.g. attribute 311 is connected to attribute 332 using a path 311 to 321 to 324 to 331 to 332). Nodes that do not have any relationship above the threshold amount between the node and a selected attribute are not considered candidates. Here, nodes 341, 342, 343, 344, and 349 are not considered candidates because there is no path from any of those nodes to any of the selected nodes 312, 331, or 332. Nodes 312, 331, and 332 also are not considered candidate nodes because they have already been selected by working graph 340. Nodes 311, 313, 314, 315, 316, 321, 322, 323, 324, 325, and 326 are all considered candidate nodes that could be suggested.

The system then evaluates each of the unselected candidate nodes to determine that node's TRR score. Attribute TRR generators are generally used to evaluate attributes, while transformation TRR generators are generally used to evaluate transformations. In some embodiments, there is no difference between attribute TRR generators and transformation TRR generators. In other embodiments, transformation TRR generators are subdivided into sub-function TRR generators. For example a system could have data transform TRR generators and metadata transform TRR generators. For each node in the candidate list of nodes, a TRR generator could create a feature vector including all attributes of each candidate node and each related selected node in the working graph, including the connecting relationship attributes. The TRR generator then could compute the TRR based on a function of the feature vector, which could include any or all of the following metrics: an RCM, global usage of the attribute relationship (UM), a user group's usage of the attribute relationship (UM), a user entity's usage of the attribute relationship (UM), the dataset relationship(s) used to join the datasets when combining the attributes, the usage of the dataset relationship(s) by the user, user group and globally (NT), and a distance to the node. Additional metrics could be added to the feature vector without departing from the scope of the invention.

Preferably, the TRR algorithm weights each feature in the feature vector based on machine learning and statistical analysis models that optimize the suggestions based on prior user selections. Exemplary TRR algorithms are disclosed in co-pending application Ser. No. 14/628,862 titled “RELEVANCE RANKING FOR DATA AND TRANSFORMATIONS,” which is incorporated herein by reference.

The resulting ranked lists of suggested attributes and transformations could then be provided to users via a user interface, or to systems via a calling system. The attributes and/or transformations could also be segmented by type in order to form a sub-list of actions or recommendations to take based on the user's or the calling system's needs. As the remote entity traverses through universe graph 300, selects attributes, and/or selects transformations, the system could record the entity's actions and alter the weights of relationships accordingly.

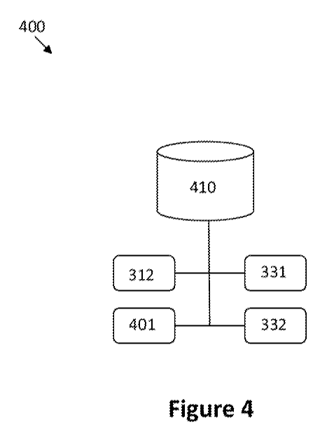

Once a user selects a set of attributes and/or transformations to construct a new dataset and saves it as a data shape, a data generation module could generate the requested dataset having those features. FIG. 4 shows a new dataset constructed based on a data shape defined by the working graph 350 of FIG. 3, which made selections 351 (attribute 312), 352 (transformation 319 to attribute 313), 353 (attribute 313), 354 (attribute 311), and 355 (attribute 332). This results in a new dataset 410 having attribute 312, 401, 331, and 332. Attribute 312 is from dataset 310. Attribute 301 is attribute 313 from dataset 310 having transform 319 applied to the attribute. Attributes 331 and 332 are from dataset 330. Attributes 331 and 332 were joined with attributes 331 and 401 using the highest RCM relationships between attributes 311 and 321, and between attributes 324 and 331. The process used the discovered data relationships identified by pathing high value RCM relationships between selected attributes, and helped a user entity discover previously unknown attributes and transformations by suggesting highly ranked attributes and transformations that are highly relevant to the selected attributes.

The working graph 350 generally defines the data shape of the new dataset 410 to be generated, and could be saved into memory as a template from which new datasets could be constructed. Working graph 350 defines the attributes (attributes 312, 313, 331, and 332), associated datasets (datasets 310, 320, and 330), relationships between attributes to link the datasets together (the relationship between attributes 311 and 321, the relationship between attribute 316 and 323, and the relationship between attribute 324 and 331), data sources for the datasets (e.g. data sources 101, 102, and 103), and the transformations used to change the attributes into the requested format (transformation 319 applied to attribute 313). The metadata associated with the attributes from the data sources could be transferred to the new dataset at any time after working graph 350 has been defined.

A system could be configured to perform one or more validations or optimizations on a data shape, including, but are not limited to, data shape bounding, RCM boosting, data shape refactoring and execution cost estimation. Once a data shape has been defined, the data shape could be used by the computer system to start one or more processes that generate the new dataset from the data sources and/or retrieved datasets. The data shape could be used to regenerate a new dataset, for example periodically or in response to a signal that a dataset belonging to the data shape has been updated. The data shape could also be shared and reused by different users and user groups. The process uses the relationships identified by deriving high value RCM relationship paths while incorporating any relationships selected by the user entity when specifying the data shape. The process also preferably incorporates selected attributes and transformations requested in the data shape. The process could also automatically incorporate suggested attributes and/or suggested transformations based on defined criteria, such as a TRR score above a defined threshold. The computer system could generate the corresponding queries and processes in the specific configurations and language of the data processing platform that the system is running on. In some embodiments, a computer system might be configured to periodically update a data shape, for instance where a new attribute might get added to a dataset of a data source or an RCM value might change due to a change in a user history, which might change the joining relationship paths if the system is set to auto-choose the highest relationship path between selected attributes.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . . and N, the text should be interpreted as requiring only one element from the group, not A plus N, or B plus N, etc.

What is claimed is:

1. A system for synthesizing a new data shape for a new dataset, the system comprising:
a data collection module configured to store, on a computer-readable memory, a plurality of datasets, each having a set of attributes, from the disparate data sources, and that stores, on the computer-readable memory, an aggregated set of attributes from the plurality of datasets;
a synthesizing engine configured to (a) establish possible relationships between data attributes of the aggregated set of attributes and (b) rank the possible relationships;
an interface module configured to (a) provide the aggregated set of attributes from the plurality of datasets to a distal computer device and (b) receive a first selection of attributes for the new data shape from the distal computer device; and
a data generation module configured to synthesize the data shape from the first selection of attributes as a function of the ranked possible relationships, wherein the interface module is configured to present a representation of the data shape to the distal computer device.

2. The system of claim 1, wherein the data shape defines at least two attributes from disparate datasets to be joined as a function of at least one of the ranked possible relationships.

3. The system of claim 1, wherein the data shape comprises a data source identifier for a designated dataset, wherein at least one of the first selection of attributes is selected from the designated dataset.

4. The system of claim 1, wherein the data shape comprises a transformation for at least one of the first selection of attributes.

5. The system of claim 1, wherein the data generation module is further configured to synthesize the new dataset as a function of the data shape.

6. The system of claim 5, wherein the interface module is further configured to present the new dataset to the distal computer device.

7. The system of claim 3, wherein the data collection module is further configured to retrieve an updated version of the designated dataset, and wherein the data generation module is further configured to synthesize the new dataset as a function of the data shape and the updated version of the designated dataset.

8. The system of claim 1, wherein the synthesizing engine is further configured to derive a set of suggested attributes that each have a relationship path connecting to at least one of the first selection of attributes, wherein the interface module is further configured to present the set of suggested attributes to the distal computer device, and wherein the interface module is further configured to receive a second selection of the set of suggested attributes.

9. The system of claim 8, wherein the synthesizing engine is further configured to generate a confidence metric for each of the possible relationships as a function of at least one advisor that analyzes attributes of each of the possible relationships, and wherein the synthesizing engine is configured to derive the set of suggested attributes only using relationship paths that have relationships with a confidence metric that exceeds a threshold amount.

10. The system of claim 8, wherein the synthesizing engine is configured to derive a TRR score for each of the set of the suggested attributes and wherein the interface module is further configured to present the set of suggested attributes as a ranked set as a function of the derived TRR score.

11. The system of claim 8, wherein the distal computer device is selected from the group consisting of (a) a calling communication system that communicates through the interface module using an API module and (b) a user interface.

12. The system of claim 1, wherein the synthesizing engine is further configured to generate a confidence metric for each of the possible relationships as a function of at least one advisor that analyzes attributes of each of the possible relationships, and wherein the synthesizing engine is configured to rank the possible relationships as a function of the generated confidence metrics.

13. The system of claim 12, wherein the synthesizing engine is configured to automatically select a preferred relationship from the ranked possible relationships as a function of the generated confidence metrics, and wherein the data generation module is configured to synthesize the new data shape from the first selection of attributes as a function of the selected preferred relationship.

14. The system of claim 12, further comprising generating a usage history for each possible relationship comprising how often attributes of the possible relationship have been used to join datasets into other historical datasets.

15. The system of claim 12, wherein the interface module is further configured to:
present a portion of the ranked relationships to a distal computer device, wherein each ranked relationship of the portion of ranked relationships has a confidence metric at least as great as the minimum confidence metric threshold; and
receive a selected relationship from the portion of the ranked relationships from the distal computer device.

16. The system of claim 15, wherein the data generation module is configured to synthesize the new data shape from the first selection of attributes as a function of the selected relationship.

17. The system of claim 1, wherein the interface module is configured to present the ranked possible relationships as a ranked list of suggested relationships.

18. The system of claim 17, wherein the ranked list of suggested relationships comprises a relationship comprising at least two attributes that are synchronized with one another using a transformation.

19. The system of claim 17, wherein the user interface is further configured to accept a selection of the suggested relationships from a user, and wherein the synthesizing engine is further configured to update a portion of the generated confidence metrics as a function of the selection.

20. The system of claim 1, wherein the synthesizing engine is further configured to derive a set of suggested transformations that each have a relationship path connecting to at least one of the first selection of attributes, wherein the synthesizing engine is further configured to derive a TRR score for each of the suggested transformations, wherein the interface module is further configured to present the set of suggested transformations as a list ranked as a function of the derived TRR score, and wherein the interface module is further configured to receive a second selection of the set of suggested transformations.
